(19) United States
(12) Patent Application Publication
(10) Pub. No.: US 2003/0222974 A1
(43) Pub. Date: Dec. 4, 2003

(54) Picture transmission system

(75) Inventors: Akio Yoneyama, Saitama (JP); Yasuyuki Nakajima, Saitama (JP); Hiromasa Yanagihara, Saitama (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: KDDI Corporation, Tokyo (JP)

(21) Appl. No.: 10/442,984

(22) Filed: May 22, 2003

(30) Foreign Application Priority Data
May 30, 2002 (JP) 2002-157879

(51) Int. Cl. H04N 7/14

(52) U.S. Cl. 348/14.12; 348/14.14; 348/14.1

(57) ABSTRACT

A video acquired by a video acquiring section of a video sender terminal is subjected to coding such as MPEG or the like by a video coding section, and the coded video is transmitted to a video receiver terminal through a communication line. In the video receiver side, the received video is decoded and displayed on a video display section. In the video receiver terminal, when a still picture acquiring instruction is made, time information is acquired from a video decoding section and transmitted to a still picture acquiring section of the video sender terminal. The still picture acquiring section reads a still picture at the same time from a video storing section, performs still picture coding such as JPEG to the still picture, and transmits the coded still picture to the video receiver terminal. In the video receiver terminal, the still picture is decoded and displayed on a still picture display section. As a result, the video receiver terminal can acquire a still picture having high quality.

### BACKGROUND OF THE INVENTION

1. Field of the Invention

The present invention relates to a picture transmission system and, more particularly, to a picture transmission system which can acquire a high-quality still picture on a receiver side as needed and which is suitably used in a video conference and the like.

2. Description of the Related Art

A conventional picture transmission system which can bidirectionally transmit and receive a video or a motion picture, e.g., a video conference system is proposed. A conventional system which is designed to acquire a still picture on a receiver side in the video conference system will be described below with reference to FIG. 7.

The sender side (video sender terminal) of the video conference system has a video acquiring section 31 such as a video camera and a video coding section 32. On the other hand, the receiver side (video receiver terminal) has a video decoding section 41 for receiving a video transmitted through a communication line to decode the video, a video display section 42 for displaying a decoded video, a still picture acquiring instruction 43, a still picture acquiring section 44 for acquiring a still picture on the basis of the still picture acquiring instruction 43, and a still picture display section 45.

In a video conference system having the above configuration, the video acquiring section 31 of the video sender terminal acquires a video, the acquired video information is subjected to coding such as MPEG by the video coding section 32, and the coded information is transmitted to the communication line. The video decoding section 41 of the video receiver terminal decodes the received coded information and transmits the decoded video to the video display section 42. The video display section 42 displays the decoded video.

When the still picture acquiring section 44 receives the still picture acquiring instruction 43, the still picture acquiring section 44 extracts video information specified in video decoded by the video decoding section 41 and transmits the video information to the still picture display section 45. The still picture display section 45 displays the received still picture.

However, there is a problem in the conventional system that, when the quality of a video transmitted from the video sender terminal, in other words, the quality of a video received by the video receiver terminal has been deteriorated by coding of the video in the video coding section 32, even though the video specified by the still picture acquiring section 44 is picked from videos decoded by the video decoding section 41, a still picture having preferable quality cannot be acquired.

### SUMMARY OF THE INVENTION

It is an object of the present invention to provide a picture transmission system which can always acquire a still picture having preferable quality on a receiver side without being influenced by video coding on a sender side.

In order to accomplish the object, according to the first aspect of the present invention, a picture transmission system comprises video input means for inputting a video, storing means for storing the video, video coding means for coding the video from the video stored in the storing means and transmitting, still picture loading means for reading a picture based on acquiring instruction from the video stored in the storing means and loading it as a still picture, and still picture coding means for coding the loaded still picture and transmitting.

According to this aspect, as a still picture is picked from a video acquired by the video acquiring section and is subjected to still picture coding, the still picture having preferable quality can be provided to a receiver side.

According to the second aspect of the present invention, the picture transmission system further comprises a still picture storing means for reading at least one picture based on acquiring instruction from the video stored in the storing means and storing them as a still picture.

According to this aspect, the picture sizes of still pictures, the formats of the still pictures, or the number of stored still pictures can be arbitrarily set independently of those of videos.

Furthermore, according to the third aspect of the present invention, time or a space of the still picture is specified by using control information transmitted from a receiver terminal. According to this aspect, the receiver side designates a picture at arbitrary time or in an arbitrary space from the received videos to make it possible to acquire a still picture of the picture, in other words, a still picture having preferable quality.

According to the fourth aspect of the present invention, the picture transmission system further includes a camera for acquiring a video which can be controlled by a receiver terminal. According to this aspect, the receiver side can designate an arbitrary position of an object while seeing a video, and a picture at a desired position can be acquired without bothering the sender side.

In addition, the picture transmission system according to the present invention further includes transmission bitrate control means for controlling a transmission bitrate of the transmission means. According to the fifth aspect of the present invention, when the transmission bitrate control means simultaneously transmits the coded video and the coded still picture, the transmission bitrate control means controls the transmission bitrates of the video and the still picture.

According to this aspect, a video and a still picture can be transmitted at transmission bitrates suitable for the video and the still picture, respectively. For example, when a transmission channel bandwidth of a communication line is limited, video transmission and still picture transmission can be performed at transmission bitrates suitable for the transmission channel bandwidth.

### BRIEF DESCRIPTION OF THE DRAWINGS

FIG. 1 is a block diagram showing the configuration of an embodiment of the present invention;

FIG. 2 is a block diagram showing the configuration of a second embodiment of the present invention;

FIG. 3 is a diagram showing a display example of a display section of a video receiver terminal;

FIG. 4 is a block diagram showing the configuration of a third embodiment of the present invention;

FIG. 5 is a diagram for explaining control example of a transmission bitrate of a coded picture;

FIG. 6 is a block diagram showing the configuration of a fourth embodiment of the present invention; and

FIG. 7 is a block diagram showing the configuration of a conventional system.

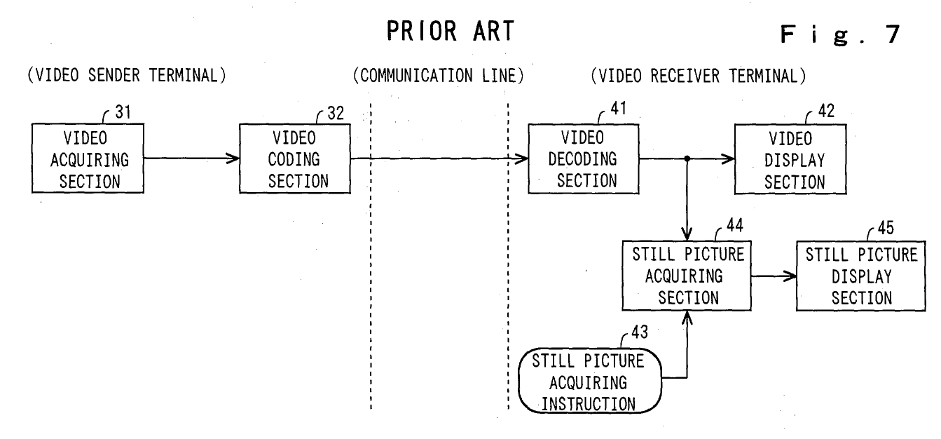

### DETAILED DESCRIPTION OF THE PREFERRED EMBODIMENTS

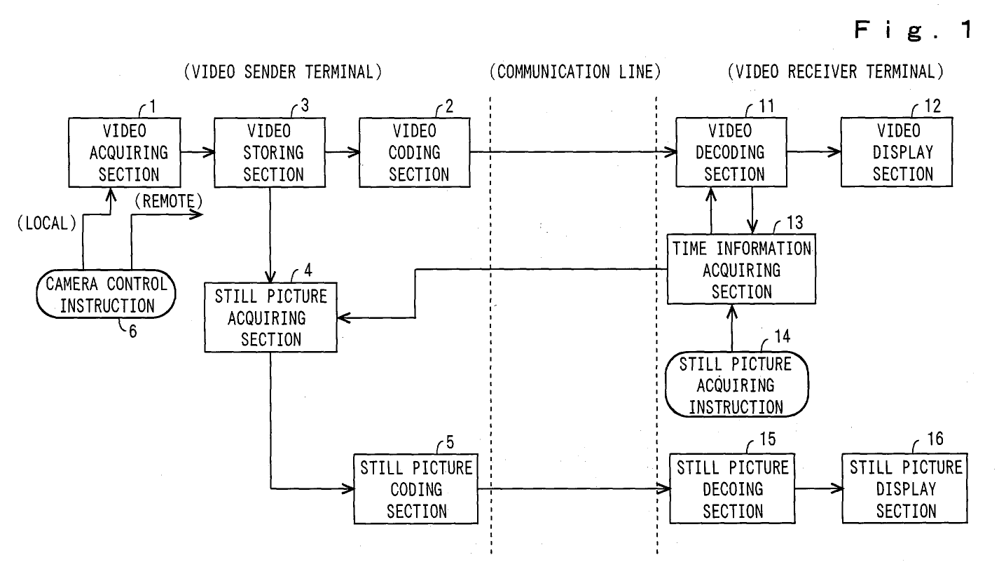

The present invention will be described below with reference to the accompanying drawings. FIG. 1 is a block diagram showing the rough configuration of a video conference system according to an embodiment of the present invention.

A video acquired by a video acquiring section 1 such as a video camera is stored together with time information at which the video is acquired by a video storing section 3. One frame-picture or a plurality of frame pictures can be stored in the video storing section 3, e.g. a ring buffer. Furthermore, in the video coding section 2, the video stored in the video storing section 3 is coded by a scheme such as MPEG. Video information coded by the video coding section 2 is transmitted to the video receiver terminal through the communication line. The video information received by the video receiver terminal is decoded by a video decoding section 11 and displayed by a video display section 12.

During a video conference, picture information of such as a micrograph, a photograph of an affected part in a medical attention, or a document screen may be desired by the receiver side. In case of a picture including contents of which must be checked in a still state, picture information transmitted or received by video coding may have insufficient quality. When picture information having preferable quality is to be obtained, a still picture acquiring instruction 14 is specified by a user or the like on the receiver side. When the still picture acquiring instruction 14 is input, a time information acquiring section 13 acquires time information of the latest decoded video from the video decoding section 11.

The time information acquiring section 13 transmits the time information to a still picture acquiring section 4 of the video sender terminal through the communication line.

The still picture acquiring section 4 picks a picture at specified time or a picture around the time from the video storing section 3 and transmits the picture to a still picture coding section 5. The still picture coding section 5 performs still picture coding such as JPEG to the received picture and transmits the coded picture to the communication line. In the still picture coding such as JPEG, unlike in video coding in which a video must be transmitted on real time, the quantity of generated code is not limited. For this reason, deterioration of the picture quality can be suppressed. In place of the time information, any identification information may be used.

The video receiver terminal receives picture information subjected to still picture coding and causes a still picture decoding section 15 to decode the picture information. The decoded still picture is displayed on a still picture display section 16. In the video sender terminal, a local or remote camera control instruction 6 can be output by a user. When the local camera control instruction 6 is output, a video camera constituting the video acquiring section 1 is controlled in direction and/or zoom. When the remote camera control instruction is output, the video camera arranged in the video receiver terminal is controlled in direction and/or zoom. By the control of the camera, an operation such as a capturing position of the still picture, enlargement and reduction (zoom) of the picture can be arbitrarily performed.

Therefore, according to this embodiment, a still picture is read from pictures stored in the video storing section 3 and can be subjected to still picture coding. For this reason, the receiver side can acquire a still picture having preferable quality.

The block diagram in FIG. 1 shows the configuration of a unidirectional transmission system. However, since the video conference system is a system which can generally perform bidirectional communication, in case of video conference system a system obtained by replacing the equipment on the sender side and the equipment on the receiver side with each other is further arranged.

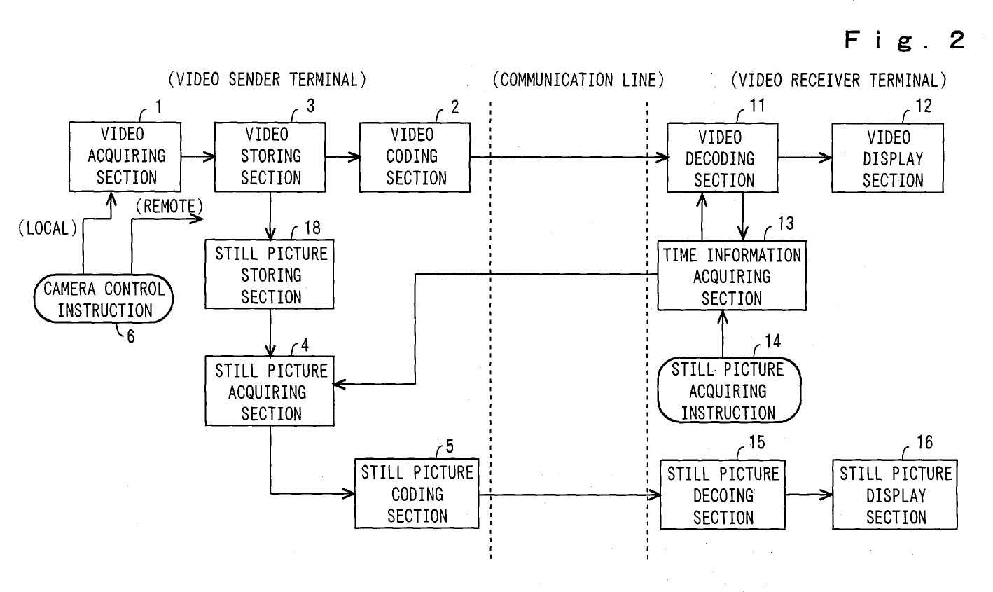

FIG. 2 is a block diagram showing the configuration of a second embodiment of the present invention. The same reference numerals as in FIG. 1 denote the same parts in FIG. 2. In this embodiment, a picture for still picture coding is acquired from videos stored in the video storing section 3 and stored in a still picture storing section 18. In the first embodiment, since a picture stored for a video and still picture is common, arbitrary sizes, formats, or the numbers of stored pictures cannot be set for the video and the still picture, respectively. However, in this embodiment, the picture sizes, the formats, or the number of stored videos for videos stored in the video storing section 3 and the picture sizes, the formats, or the number of stored pictures for still pictures stored in the still picture storing section 18 can be arbitrarily set.

When picture size or format of a picture of the still picture storing section 18 is changed from a picture of the video storing section 3, any converting means for these pictures is necessary.

A difference between the first embodiment and this embodiment will be concretely described below. For example, when acquisition of a still picture is specified to retrospectively cope with still pictures obtained during past n seconds (e.g., n=3 to 5), in the first embodiment, the latest picture to pictures obtained during past n seconds must be stored in the video storing section 3. However, if the picture size of a still picture is set to be smaller than the picture size of a video, still pictures having small picture sizes and obtained during past n seconds are stored in the still picture storing section 18, and only a small number of latest pictures required for video coding may be stored in the video storing section 3. For this reason, an amount of storage in the video storing section 3 can be suppressed to a low level. As a result, a total amount of storage can be reduced.

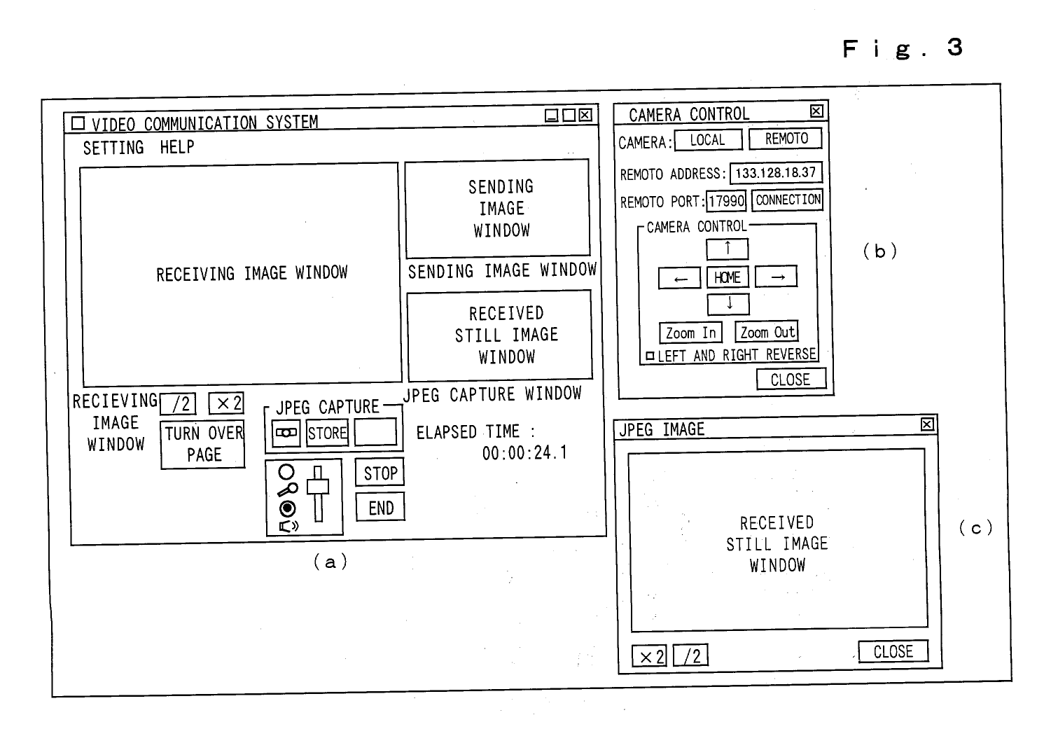

FIG. 3 is a display example of a display screen of the video receiver terminal. On the display screen, (a) “video communication system” window, (b) “camera control” window, and (c) “JPEG image” window are simultaneously opened. A ‘JPEG capture’ button on the “video communication system” window corresponds to the still picture acquiring instruction 14 in FIG. 1. When the JPEG capture button is clicked, a still picture acquiring instruction can be generated. In addition, when the camera control button is operated such that the “local” or the “remote” on the “camera control” window is specified, a video camera (not shown) of the video acquiring section arranged in the video sender terminal or the receiver terminal can be moved back and forth and left and right, and a zoom-in operation and a zoom-out operation can be performed. These buttons correspond to the camera control instruction 6 in FIG. 1.

A video can be displayed on a receiver window of the “video communication system” window, and a still picture obtained by operating the JPEG capture button can be displayed on a received still image window. The still picture can be displayed on (c) “JPEG image” window as an enlarged picture. A stop button is a button for generating an instruction for stopping transmission, and an end button is a button for terminating the software. It is apparent that the display screen of the video sender terminal is the same as that in FIG. 3. The still picture coding scheme in this system is not limited to JPEG, and can be replaced with an arbitrary still picture coding scheme.

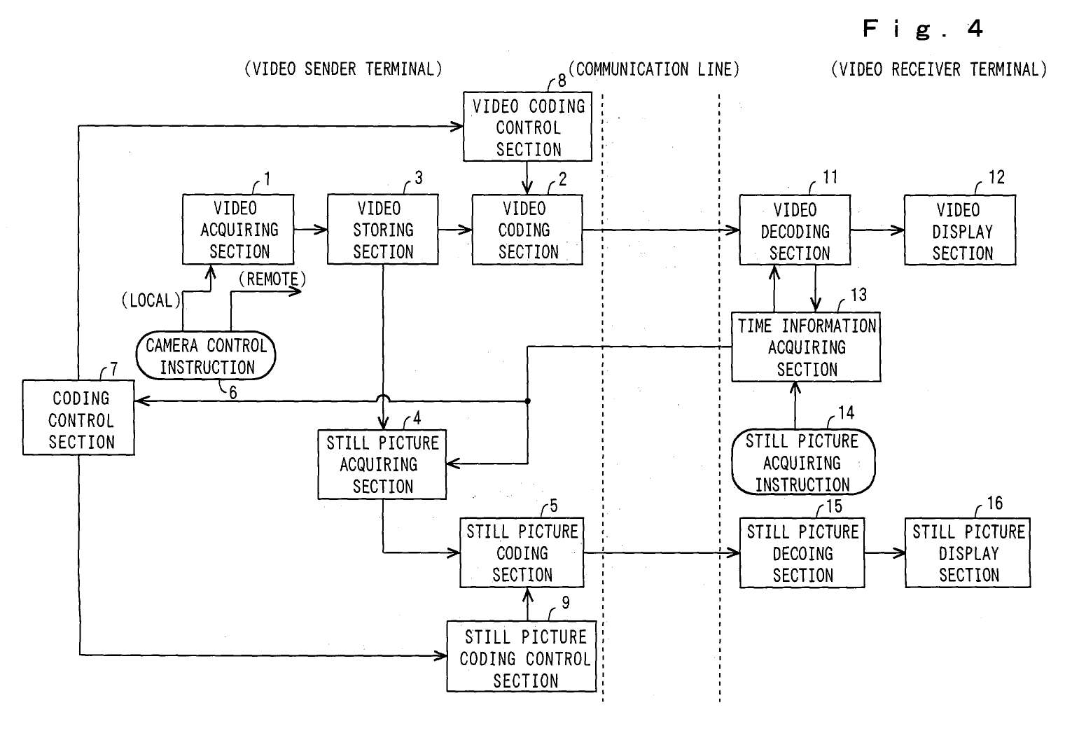

A third embodiment of the present invention will be described below with reference to FIG. 4. This embodiment is different from the first embodiment in that a coding control section 7, a video coding control section 8, and a still picture coding control section 9 are arranged in the video sender terminal. The other configuration of the third embodiment is the same as or equal to the configuration of the first embodiment. The video coding control section 8 controls a coding bitrate and a transmission bitrate of a video, and the still picture coding control section 9 controls coding and transmission bitrates of a still picture. The coding control section 7 controls both the video coding control section 8 and the still picture coding control section 9.

When the still picture acquiring instruction 14 is made, and the time information acquiring section 13 transmits time information obtained from the video decoding section 11 to the video sender terminal through a communication line, the time information is received by the still picture acquiring section 4 and the coding control section 7. In this manner, the still picture acquiring section 4, as in the first embodiment, picks a picture obtained at specified time from the video storing section 3 and transmits the picture to the still picture coding section 5. The still picture coding section 5 performs still picture coding such as JPEG to the received picture and transmits the picture to the communication line.

On the other hand, the coding control section 7 decides that an instruction for acquiring a still picture is made on the basis of the time information, and controls the coding bitrate and the transmission bitrate of the video and the still picture for the video coding control section 8 and the still picture coding control section 9.

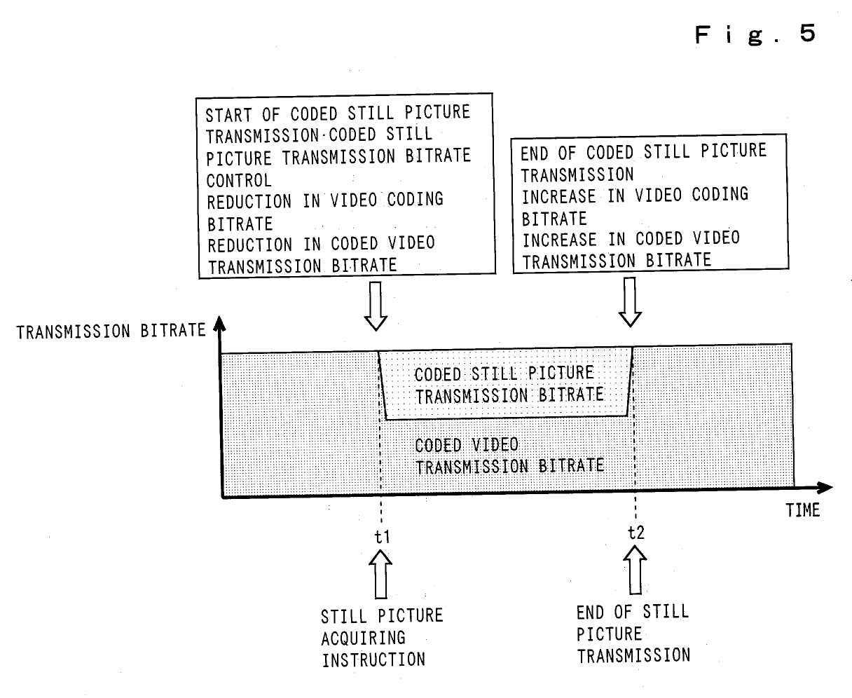

An example of the control will be described below with reference to FIG. 5. In FIG. 5, the abscissa indicates time, and the ordinate denotes a transmission bitrate. If a still picture acquiring instruction is made at time t1, the coding control section 7 starts coded still picture transmission and sends an instruction for controlling a coded still picture transmission bitrate to the still picture coding control section 9. An instruction for reducing a video coding bitrate and a coded video transmission bitrate is sent to the video coding control section 8. In this manner, when the transmission bitrate of the still picture and the transmission bitrate of the video are limited, and when a transmission channel bandwidth of a communication line between the sender terminal and the receiver terminal is limited, even though still picture transmission is performed, receiving and playback of the video can be prevented from being interrupted. The transmission bitrate is preferably controlled such that the sum of the coded still picture transmission bitrate and the coded video transmission bitrate is almost equal to a transmission bitrate obtained before the still picture acquiring instruction. Upon completion of still picture transmission at time t2, the coding control section 7 resumes the coded video transmission bitrate to the transmission bitrate obtained before the still picture acquiring instruction.

As described above, according to this embodiment, when the transmission channel bandwidth of the communication line is limited, receiving and playback of a video can be prevented from being interrupted by still picture transmission. The transmission bitrate of audio information may be added to the transmission bitrate of the still picture and/or the video to determine the respective transmission bitrates.

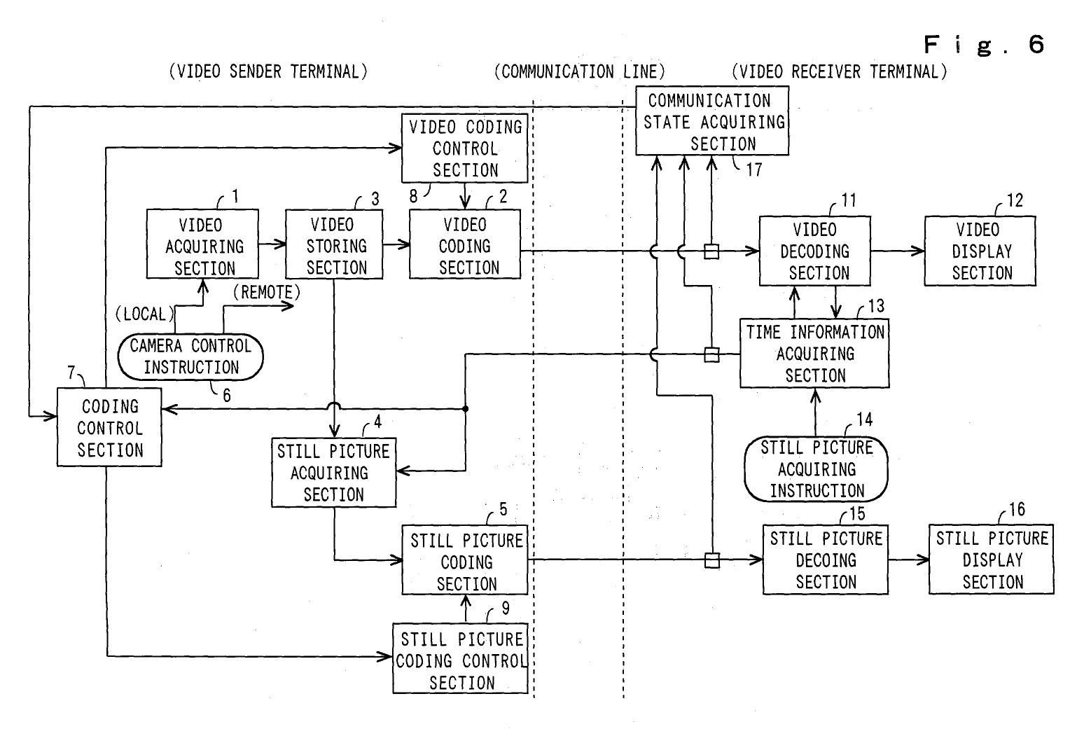

A fourth embodiment of the present invention will be described below with reference to FIG. 6. This embodiment is different from the third embodiment in that a communication state acquiring section 17 is arranged in a video receiver terminal. The other configuration of the fourth embodiment is the same as or equal to the configuration of the third embodiment.

The communication state acquiring section 17 acquires communication states such as a bit rate (throughput), a packet loss rate, jitter of a received signal when the still picture acquiring instruction 14 is made. The communication states are transmitted to the coding control section 7. The coding control section 7 controls the sum of: the coded still picture transmission bitrate and the coded video transmission bitrate during still picture transmission depending on the communication states. For example, when the bit rate, the packet loss rate, and the jitter of the signal become large, the control is performed to reduce the sum of the transmission bitrates.

In this manner, according to this embodiment, an actual line communication state can be reflected on the coding bitrates and the transmission bitrates of the video and the still picture.

As is apparent from the above description, according to this invention, the following advantages can be achieved.

(1) A still picture is picked from a video acquired by the video acquiring section and is subjected to still picture coding, and picture information obtained by the still picture coding can be transmitted to a receiver side. For this reason, a still picture having preferable quality can be provided to the receiver side. The invention is preferably used when picture information of a micrograph, a photograph of an affected part in a medical attention, or a document screen is transmitted to a receiver side at high accuracy in, e.g., a video conference.

(2) The picture sizes of still pictures, the formats of the still pictures, or the number of stored still pictures can be arbitrarily set independently of those of videos.

(3) A still picture can be specified by a simple operation on a receiver side, so that the receiver side can acquire a desired still picture without bothering a sender side.

(4) A position where an object is photographed by a camera can be changed by a simple operation, and the position can be instructed to be changed on the receiver side.

(5) Coded videos and still pictures can be transmitted at transmission bitrates suitable for these videos and still pictures, respectively, or can be transmitted at transmission bitrates suitable for the transmission channel bandwidth or the like of a communication line.

What is claimed is:

1. A picture transmission system comprising:
video input means for inputting a video;
storing means for storing the video;
video coding means for coding the video stored in the storing means and transmitting;
still picture loading means for reading a picture based on acquiring instruction from the video stored in the storing means and loading it as a still picture; and
still picture coding means for coding the loaded still picture and transmitting.

2. The picture transmission system according to claim 1, wherein
the storing means for storing the video comprises a ring buffer to make it possible that predetermined duration of video is always stored from the latest video.

3. The picture transmission system according to claim 1, wherein
picture data given to the still picture coding means is set at a picture obtained at time closest to specified time in the picture stored in the storing means.

4. A picture transmission system comprising:
video input means for inputting a video;
storing means for storing the video;
video coding means for coding the video stored in the storing means and transmitting;
still picture storing means for reading at least one picture based on acquiring instruction from the video stored in the storing means and storing them as a still picture;
still picture loading means for loading the still picture stored in the still picture storing means; and
still picture coding means for coding the loaded still picture and transmitting.

5. The picture transmission system according to claim 1, further comprising:
a coding controller for controlling coding processes of the video coding means and the still picture coding means.

6. The picture transmission system according to claim 4, further comprising:
a coding controller for controlling coding processes of the video coding means and the still picture coding means.

7. The picture transmission system according to claim 5,
the coding controller controls a transmission bitrate of the coded video and/or the coded still picture, wherein it controls transmission bitrates of the coded video and the coded still picture with relationship between them when the coded video and the coded still picture are simultaneously transmitted.

8. The picture transmission system according to claim 6,
the coding controller controls a transmission bitrate of the coded video and/or the coded still picture, wherein it controls transmission bitrates of the coded video and the coded still picture with relationship between them when the coded video and the coded still picture are simultaneously transmitted.

9. The picture transmission system according to claim 7,
the transmission bitrate is determined depterminating on communication state information notified by a picture receiver terminal.

10. The picture transmission system according to claim 8,
the transmission bitrate is determined depterminating on communication state information notified by a picture receiver terminal.

11. The picture transmission system according to claim 7,
the transmission bitrate is determined such that a sum of the transmission bitrates is a specified value.

12. The picture transmission system according to claim 8,
the transmission bitrate is determined such that a sum of the transmission bitrates is a specified value.

13. The picture transmission system according to claim 1,
the still picture loading means loads a specified still picture by control information sent from a video receiver terminal through a communication line.

14. The picture transmission system according to claim 4,
the still picture loading means loads at least one specified still picture by control information sent from a video receiver terminal through a communication line.

15. The picture transmission system according to claim 13,
the control information is a time.

16. The picture transmission system according to claim 14,
the control information is a time.

17. The picture transmission system according to claim 1,
further comprising:
a camera for acquiring the video input to the video input means; and
means for controlling the camera, and wherein
the camera can also be controlled by at least one of the video sender terminal and the video receiver terminal.

18. The picture transmission system according to claim 4,
further comprising:
a camera for acquiring the video input to the video input means; and
means for controlling the camera, and wherein
the camera can also be controlled by at least one of the video sender terminal and the video receiver terminal.
